(19) United States
(12) Patent Application Publication
(10) Pub. No.: US 2010/0277323 A1
(43) Pub. Date: Nov. 4, 2010

(54) ANTI-THEFT TAG FOR AN ELONGATE MEMBER

(75) Inventors: Jeffrey Feibelman, Providence, RI (US); David Wayne Brown, Cumberland, RI (US)

Correspondence Address: BAINWOOD HUANG & ASSOCIATES LLC, 2 CONNECTOR ROAD, WESTBOROUGH, MA, 01581, US

(73) Assignee: DISPLAY TECHNOLOGIES, INC., Johnston, RI (US)

(21) Appl. No.: 12/434,821

(22) Filed: May 4, 2009

(51) Int. Cl. G08B 13/14

(52) U.S. Cl. 340/572.8; 340/572.9

(57) ABSTRACT

An anti-theft tag includes a housing constructed and arranged to support an electronic article surveillance (EAS) sensor and at least one adhesive tape member carried by and extending from the housing. The at least one adhesive tape member is constructed and arranged to be positioned between a first state to allow positioning of at least a portion of an article in proximity to the housing and a second state wherein the at least one adhesive tape member is disposed about the housing and about the at least a portion of the article to secure the housing to the at least a portion of the article.

### BACKGROUND

The theft of small articles in retail establishments is a prevalent problem which costs merchandisers millions of dollars every year in losses. Additionally, controlling this type of theft can be very difficult since a thief can remove the small articles from an establishment without paying for them by simply wear or concealing the items prior to exiting the establishment.

Various devices have been utilized by retailers in order to prevent theft of their goods. For example, a widespread practice in the industry of article security is the use of anti-theft tags which incorporate electronic article surveillance (EAS) sensors. Such EAS sensors are typically secured to an article and are either removed by a store's employee or are rendered inactive by an employee at checkout. If the EAS sensors are not rendered inactive or removed prior to the customer exiting the store, the EAS sensors are typically sensed in the store by an associated EAS system that, in turn, causes an alarm to signal.

### SUMMARY

For many products, electronic sensors have been very effective in deterring theft. However, certain conventional EAS sensors suffer from a variety of deficiencies. For example, certain EAS sensors can be difficult to attach to certain types of merchandise. In particular, EAS sensors can be difficult to attach to certain types of items, such as eyeglasses, because of the limited areas on which the EAS sensors can be disposed. For example, certain EAS sensors can be secured to, and hang from, a nose bridge portion of a pair of eyeglasses. However, these EAS sensors can hamper a customer's ability to try on the eyeglasses, as the sensor makes it difficult for the customer to properly seat the glasses on his or her face. Additionally, such hanging EAS sensors can, in certain instances, be easily removed from the eyeglasses by a customer prior to checkout. As a result, the eyeglasses can be removed from the store by the customer without payment and without causing the store's EAS system to generate an alarm.

By contrast to conventional EAS sensors, embodiments of the present invention relate to an anti-theft tag that is securable to a generally elongate article or member, such as an arm of a pair of eyeglasses, or any generally cylindrically shaped article, such as a flashlight, perfume bottle, or beverage bottle, and that minimizes the ability for a thief to readily remove the anti-theft tag from the article prior to exiting a surveillance area of an establishment.

In one embodiment, the anti-theft tag includes a housing constructed and arranged to support an electronic article surveillance (EAS) sensor and at least one adhesive tape member carried by and extending from the housing. The at least one adhesive tape member is constructed and arranged to be positioned between a first state to allow positioning of at least a portion of an article in proximity to the housing and a second state wherein the at least one adhesive tape member is disposed about at least a portion of the housing and about the at least a portion of the article to secure the housing to the at least a portion of the article.

In one embodiment, the anti-theft tag includes a housing constructed and arranged to support an EAS sensor, a first adhesive tape member carried by and extending from the housing, and a second adhesive tape member carried by and extending from the housing. The first adhesive tape member defines a first member longitudinal axis with the first adhesive tape member extending from the housing such that the first member longitudinal axis of the first adhesive tape member is substantially perpendicular to a longitudinal axis of the housing. The first adhesive tape member is constructed and arranged to be positioned between a first state to allow positioning of at least a portion of an article in proximity to the housing and a second state wherein the first adhesive tape member is disposed about at least a portion of the housing and about the at least a portion of the article to secure the housing to the at least a portion of the article. The second adhesive tape member defines a second member longitudinal axis where the second adhesive tape member extending from the housing such that the second member longitudinal axis of the second adhesive tape member is substantially perpendicular to the longitudinal axis of the housing. The second adhesive tape member is constructed and arranged to be positioned between a first state to allow positioning of at least a portion of an article in proximity to the housing and a second state wherein the second adhesive tape member is disposed about at least a portion of the housing and about the at least a portion of the article to secure the anti-theft tag to the at least a portion of the article.

### BRIEF DESCRIPTION OF THE DRAWINGS

The foregoing and other objects, features and advantages will be apparent from the following description of particular embodiments of the invention, as illustrated in the accompanying drawings in which like reference characters refer to the same parts throughout the different views. The drawings are not necessarily to scale, emphasis instead being placed upon illustrating the principles of various embodiments of the invention.

FIG. 1 illustrates an anti-theft tag applied to an elongate member of an article.

FIG. 2 is a perspective view of an embodiment of an anti-theft tag as shown in FIG. 1.

FIG. 3 is a side view of an anti-theft tag, as shown in FIG. 2.

FIG. 4 is a front perspective view of the anti-theft tag of FIG. 2 in an open state, prior to attachment to the elongate member.

FIG. 5 is a rear perspective view of the anti-theft tag of FIG. 2 in an open state, prior to attachment to the elongate member.

FIG. 6 is a perspective view of an alternate embodiment of the anti-theft tag of FIG. 1.

FIG. 7 is a front perspective view of the anti-theft tag of FIG. 6 in an open state, prior to attachment to the elongate member

FIG. 8 is a rear perspective view of the anti-theft tag of FIG. 2 in an open state, prior to attachment to the elongate member.

FIG. 9 is a side view of the anti-theft tag, as shown in FIG. 2, having an adhesive tape member disposed about a housing of the anti-theft tag.

### DETAILED DESCRIPTION

Embodiments of the present invention relate to an anti-theft tag that is securable to an article, such as a pair of eyeglasses, and that minimizes the ability for a user to readily remove the anti-theft tag from the article prior to exiting a surveillance area of an establishment. For example, the anti-theft tag includes a housing that carries an EAS sensor and one or more adhesive tape members extending from the housing. In use, when the anti-theft tag is placed alongside an elongate portion or member of the article, a user wraps the adhesive tape members about at least a portion of the housing and the elongate member of the article to secure the anti-theft tag to the elongate member of the article. The adhesive tape members allow the user to secure the anti-theft tag to the article at the point of purchase without requiring the use of additional elements or specialized equipment. Additionally, the use of the adhesive tape members allow limits the ability for an unauthorized user to remove the anti-theft tag from the article prior to leaving the point-of-purchase location.

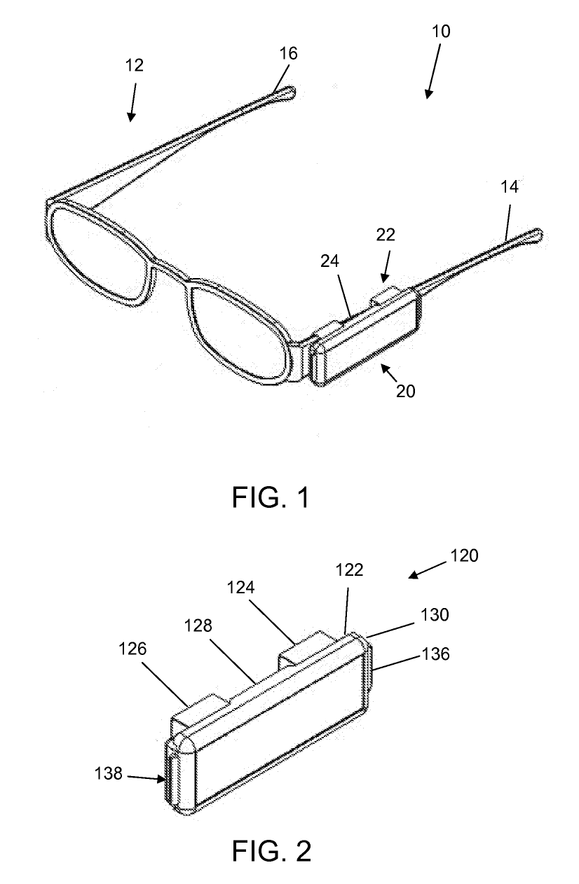

FIG. 1 illustrates an article assembly 10 that includes an article 12 and an anti-theft tag 20. For example, as shown, the article 12 is configured as a pair of sunglasses having a pair of elongate arms 14, 16. The anti-theft tag 20 carries an EAS sensor and is secured to one of the elongate arms 14 to minimize or prevent theft of the article 12 from a retail outlet. The anti-theft tag 20 includes at least one adhesive tape member 22 to secure the anti-theft tag 20 to the elongate arm 14 and to limit or prevent removal of the anti-theft tag 20 from the article 12. For example, as will be described in detail below, the adhesive tape member 22 is configured to be wrapped about a portion of a housing 24 of the anti-theft tag 20 and the elongate arm 14 to secure the anti-theft tag 20 to the article 12. Accordingly, the adhesive tape member 22 secures the housing 24 of the anti-theft tag against the elongate arm 14, thereby limiting the ability of a user to remove the anti-theft tag 20 from the article 12 by twisting or rotating the anti-theft tag 20 relative to the elongate arm 14.

The anti-theft tag 20 can be configured in a variety of ways. One configuration of an anti-theft tag 120 is illustrated in FIGS. 2-5. As illustrated, the anti-theft tag 120 includes a housing 122 having a first adhesive tape member 124 and a second adhesive tape member 126 carried by, and extending from, the housing 122.

The housing 122 is generally rectangular in shape and is configured to be held against an elongate member of an article by the first and second adhesive tape members 124, 126. The housing 122 can include a label (not shown) disposed on an outer surface of the housing 122 to provide information about the article to which the anti-theft tag 120 is secured. For example, the label can include indicia which identifies the manufacturer, brand name, and/or model name of the article or a bar code that identifies the article.

The housing 122 is configured to carry an electronic article surveillance (EAS) sensor, such as an amplitude modulation (AM) sensor 132, which sets off an alarm if the AM sensor 132 is carried beyond a surveillance area before the AM sensor 132 is deactivated. In one arrangement, the housing 122 includes a first housing portion 128 and a second housing portion 130.

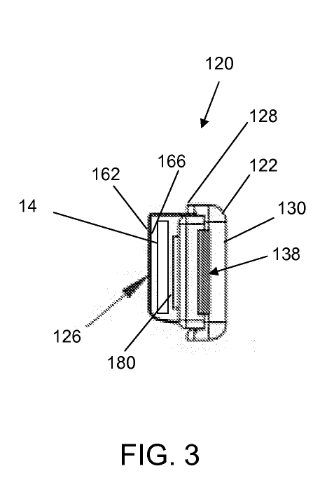

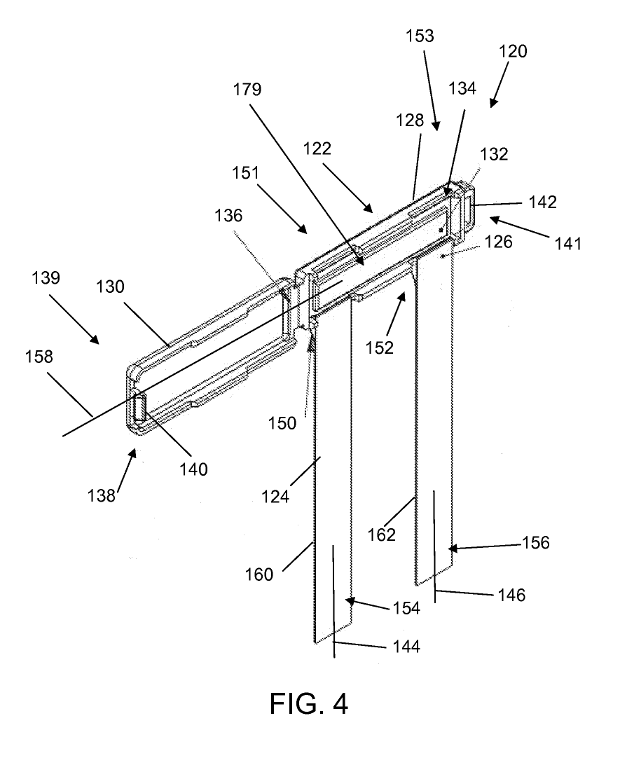

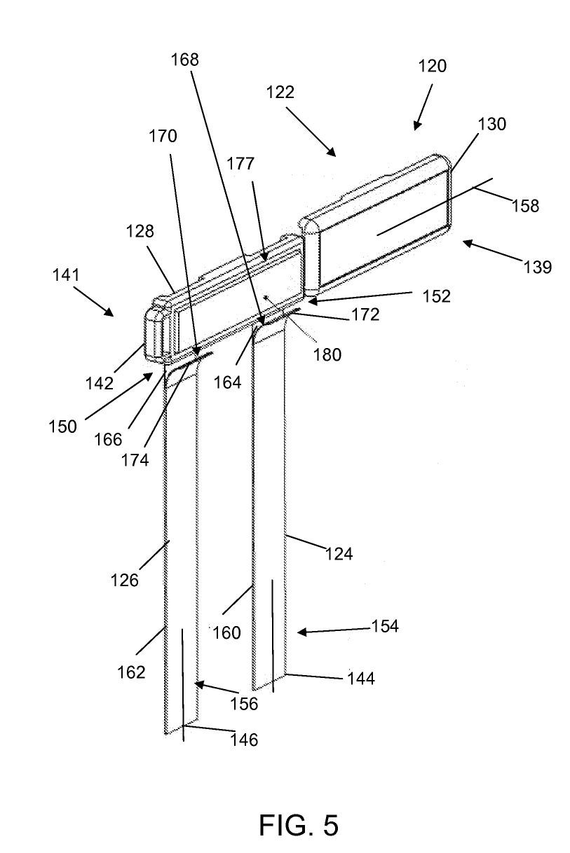

The first housing portion 128 defines a cavity 134 configured to carry the AM sensor 132. For example, as illustrated in FIG. 4, the first housing portion 128 defines the cavity 134 as being sized and shaped to receive the AM sensor 132. While the first housing portion 128 can carry the AM sensor 132 in a variety of ways, in one arrangement, the AM sensor 132 is disposed within the cavity 134 and adhered to the first housing portion 128 within the cavity 134. The second housing portion 130 is configured to cover and conceal the AM sensor 132 within the anti-theft tag 120. In one arrangement, the second housing portion 130 is hingedly attached to the first housing portion 128 by a hinge member 136 integrally formed with the first and second housing portions 128, 130. For example, during a manufacturing process, the first and second housing portions 128, 130 and the hinge member 136 are formed by an injection-molding process from a material such as plastic. In such an arrangement, the hinge member 136 is formed as a relatively thin strip of material that allows the second housing portion 130 to be positioned between a first, open position, as shown in FIGS. 4 and 5, and a second, closed position, as shown in FIGS. 2 and 3, to completely enclose the AM sensor 132 within the housing 122.

In one arrangement, the housing 122 includes a securing mechanism 138 configured to secure a free end 139 of the first housing portion 128 and a free end 141 of the second housing portion 130 when the anti-theft tag 120 is placed in a closed position. For example, the securing mechanism 138 includes a latch 140 and a latch receptacle 142 where the latch 140 is disposed on a portion of the second housing portion 130 opposing the hinge member 136 and the latch receptacle 142 is disposed on a portion of the first housing portion 128 opposing the hinge member 136. When the second housing portion 130 is positioned in the closed position, the latch 140 enters and interacts with the latch receptacle 142 to secure the free end 139 of the second housing portion 130 to the free end 141 of the first housing portion 128. Such interaction between the latch 140 and the latch receptacle 142 maintains the AM sensor 132 within the housing 122 and limits the ability for a user to remove the AM sensor 132 from the anti-theft tag 120.

As indicated above, the anti-theft tag 122 includes a first adhesive tape member 124 and a second adhesive tape member 126 configured to secure the anti-theft tag 120 to an elongate member of an article, such as an arm of a pair of eyeglasses. For example, each of the first and second adhesive tape members 124, 126 are formed from a generally flexible material where the flexible material is configured to be wrapped about at least a portion of the housing 122 and an elongate member of an article while remaining intact. In one arrangement, each of the first and second adhesive tape members 124, 126 are formed as rectangular shaped strips where each of the first and second adhesive tape members 124, 126 define a longitudinal axis 144, 146, respectively. First ends 150, 152 of the respective first and second adhesive tape members 124, 126 are captured and secured between the AM sensor 132 and the first housing portion 128. For example, the first adhesive tape member 124 is disposed at a first end 151 of the first housing portion 128 and the second adhesive tape member 126 is disposed at a second end 153 of the first housing portion 128. Second ends 154, 156 of the respective first and second adhesive tape members 124, 126 extend from the first housing portion 128 such that the longitudinal axes 144, 146 of the first and second adhesive tape members 124, 126 are substantially perpendicular to a longitudinal axis 158 of the housing 122. In use, with such a configuration, as a user wraps the first and second adhesive tape members 124, 126 about at least a portion of the housing 122 and an elongate member of an article, the user can securely fasten the anti-theft tag 120 to the article while distributing the fastening load along a length of the anti-theft tag housing 122.

In one arrangement, the first and second adhesive tape members 124, 126 include, respectively, a carrier layer 160, 162 having an adhesive 164, 166 disposed on a surface of the carrier layer 160, 162. While the carrier layer 160, 162 can be formed from a variety of materials, in one arrangement, the carrier layer 160, 162 is formed of a an elastically compliant material, such as polyvinyl chloride (PVC) or other plastic-based materials. While the adhesive 164, 166 can be formed from a variety of materials, in one arrangement, the adhesive 164, 166 is formulated to be removed cleanly from an article to which it is attached when a user removes the anti-theft tag 10 from the article. As such, once removed, the amount of residue left by the second adhesive surface 102 on the article is minimized. In one arrangement, the adhesive 164, 166 can be formulated to minimize chemical interaction with the article to limit or prevent degradation or corrosion of the article once secured thereto.

In order to minimize inadvertent contact between the adhesive 164, 166 of the first and second adhesive tape members 124, 126 and an article prior to attachment of the anti-theft tag 120 to the article, the first and second adhesive tape members 124, 126 include respective adhesive tape member coverings 168, 170, respectively, that extend along a length of the first and second adhesive tape members 124, 126. For example, the adhesive tape member coverings 168, 170 are disposed on the adhesive surfaces 164, 166 of the carrier layers 160, 162. In one arrangement, the adhesive tape member coverings 168, 170 include ends 172, 174 that extend past a juncture of the first and second adhesive tape members 124, 126 and the first housing portion 128. With such a configuration, the ends 172, 174 allow a user to readily grasp the adhesive tape member coverings 168, 170 in order to remove the adhesive tape member coverings 168, 170 from the first and second adhesive tape members 124, 126.

With respect to the anti-theft tag 120 described above, an assembler can apply the anti-theft tag 120 to a wide variety of articles. For example, the assembler can apply the anti-theft tag 10 to an elongate member, such as an arm of a pair of eyeglasses 12 as illustrated in FIG. 1.

In use, when securing the anti-theft tag 120 to an elongate member of an article, an assembler first places the elongate member in proximity to the housing 122 of the anti-theft tag 102. In one arrangement, prior to attaching to the article, the anti-theft tag 102 is disposed in an open state, as illustrated in FIGS. 4 and 5. In such an arrangement, and taking the pair of eyeglasses 12 of FIG. 1 as an example of an article, an assembler places the arm 14 of the pair of eyeglasses 12 against an outer face portion 177 of the first housing portion 128 of the housing 122 such that a longitudinal axis of the arm 14 is substantially parallel to the longitudinal axis 158 of the housing 122.

After removing the adhesive tape member covering 168 from the first adhesive tape member 124, the assembler rotates the second end 154 of the first adhesive tape member 124 relative to the longitudinal axis 158 of the housing 122 such that the adhesive layer 164 of the first adhesive tape member 124 contacts the arm 14. The assembler then continues to rotate the first adhesive tape member 124 relative to the longitudinal axis 158 of the housing 122, thereby shortening an overall length of the of the first adhesive tape member 124 and causing the first adhesive tape member 124 to contact an inner portion 179 of the first housing portion 128, such as the AM sensor 132, and to further secure the anti-theft tag 120 to the arm 16. Further rotation of the second end 154 of the first adhesive tape member 124 relative to the longitudinal axis 158 of the housing 122 causes the adhesive layer 164 of the first adhesive tape member 124 to contact a non-adhesive bearing surface of the first adhesive tape member's carrier layer 160. Accordingly, the first adhesive tape member 124 is disposed about, or encircles, the arm 14 (i.e., the elongate member) and the first housing portion 128 of the anti-theft tag 120 to secure the first end 151 of the housing 122 to the arm. The assembler then repeats the process with the second adhesive tape member 124 to secure the second end 153 of the housing 122 to the arm 16.

With the first housing portion 128 secured to the arm 14, the assembler folds the second housing portion 130 about the hinge member 136, relative to the first housing portion 128 and inserts the latch 140 within the latch receptacle 142 to secure the free end 139 of the second housing portion 130 to the free end 141 of the first housing portion 128. The anti-theft tag 120 is shown in such a closed position in FIG. 2. By closing the second housing portion 130 onto the first housing portion 128, the assembler encloses the AM sensor 132 within the housing to limit access to the AM sensor 132. Additionally, by closing the second housing portion 130 onto the first housing portion 128, the assembler encloses at least a portion of the first and second adhesive tape members 124 within the housing 122 to limit an unauthorized user's access to the first and second adhesive tape members 124.

Such a configuration of anti-theft tag 120 minimizes the ability for an unauthorized user to purposely remove the anti-theft tag 120 from an elongate member once the anti-theft tag 120 has been secured to the elongate member. For example, with respect to FIG. 1, once the first and second adhesive tape members 124, 126 have been wrapped about the arm 14 and the first housing portion 128 and the second housing portion 130 has been closed and secured to the first housing portion, the first and second adhesive tape members 124, 126 hold the housing 122 of the anti-theft tag 120 against the arm 14. Such positioning of the housing 122 relative to the arm 14 limits the ability for a thief to twist or rotate the housing 122 of the anti-theft tag 120 relative to the arm 14 of the eyeglasses 12 in an attempt to separate the AM sensor 132 contained within the housing 122 from the pair of eyeglasses 12. Additionally, the adhesive tape members 124, 126 allow the assembler to secure the anti-theft tag 120 to an article at the article's point of purchase without requiring the use of additional elements or specialized equipment.

While the adhesive tape members 124, 126 are configured to secure the anti-theft tag 120 to an article, the anti-theft tag 120 can include additional securing mechanisms to help deter removal of the anti-theft tag 120 from an article prior to purchase. For example, the anti-theft tag 120 includes a contact pad 180 carried by the first housing portion 128.

In one arrangement, the contact pad 180 is configured as an elastomeric or foam pad disposed on the first housing portion 128. When the adhesive tape members 124, 126 secure the housing 122 of the anti-theft tag 120 to an elongate member, such as an arm of a pair of eyeglasses, the elastomeric pad follows or conforms to a contour of the arm to which the anti-theft tag 120 is attached. Interaction between the elastomeric pad and the arm minimizes or prevents longitudinal or sliding movement of the housing 122 along the length of the arm. By limiting the ability for an unauthorized user or thief to slide the anti-theft tag 120 along a longitudinal axis of the arm 80, the elastomeric pad further secures the anti-theft tag 120 to the arm and minimizes or prevents removal of the anti-theft tag 10 from the elongate member.

In one arrangement, the contact pad 180 is configured as an adhesive pad disposed on the first housing portion 128. In one arrangement, the adhesive pad includes an adhesive covering, such as a plastic film, disposed on the adhesive pad and configured to minimize contact between the adhesive and an article prior to an assembly process. In use, prior to wrapping the adhesive tape members 124, 126 about an elongate member and a portion of the housing 122, an assembler removes the adhesive covering from the adhesive pad and makes contact between the adhesive pad and the elongate member. The adhesive pad secures the anti-theft tag 10 to the elongate member, such as an arm of a pair of eyeglasses. Accordingly, the adhesive pad helps the anti-theft tag 120 to maintain its position on the elongate member while an assembler wraps the first and second adhesive tape members 124, 126 about the arm and the housing 122 of the anti-theft tag 120. Additionally, once the anti-theft tag 10 has been secured to the elongate member, the adhesive pad limits or prevents lateral translation of the anti-theft tag 120 along a longitudinal axis of the elongate member. For example, the adhesive material 90 limits the ability for a thief to slide the anti-theft tag 120 along a longitudinal axis of the arm to remove the anti-theft tag 120 from the pair of eyeglasses.

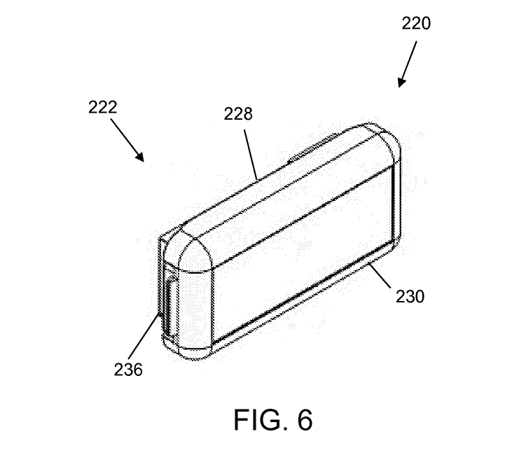

As indicated above with respect to FIGS. 2-5, the anti-theft tag 120 is configured to house an AM sensor 132. However, an anti-theft tag can be configured to house a variety of EAS sensors. In one arrangement, as illustrated in FIGS. 6-8, an anti-theft tag 220 includes a housing 222 is configured to carry a radio frequency (RF) sensor 232. The RF sensor 232 is operable which sets off an alarm if the RF sensor 232 is carried beyond a surveillance area before the RF sensor 232 is deactivated. In one arrangement, the housing 222 includes a first housing portion 228 and a second housing portion 230.

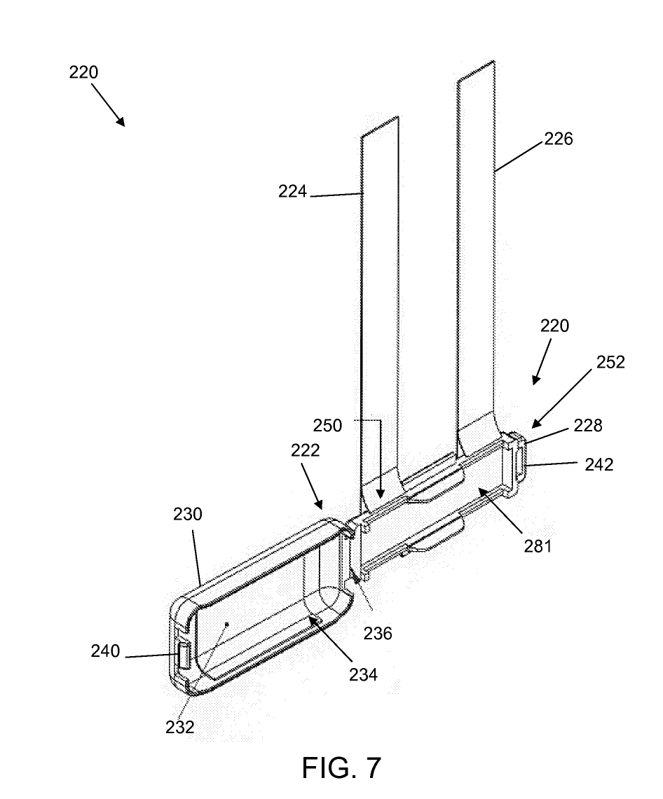

As indicated in FIGS. 6-8, the first housing portion 228 is configured to carry first and second adhesive tape members 224, 226. In one arrangement, ends 250, 252 of the respective first and second adhesive tape members 224, 226 are captured and secured between a contact pad 280 and the first housing portion 228. The second housing portion 230 is constructed and arranged to carry the RF sensor 232. In one arrangement, the second housing portion 230 defines a cavity 234 configured to carry the RF sensor 232. For example, as illustrated in FIG. 7, the second housing portion 230 defines the cavity 234 as being sized and shaped to receive the RF sensor 232. While the second housing portion 230 can carry the RF sensor 232 in a variety of ways, in one arrangement, the RF sensor 232 is disposed within the cavity 234 and adhered to the second housing portion 230 within the cavity 234.

As indicated in FIGS. 6-8, interaction between the first housing portion 228 and the second housing portion 230 130 is configured to cover and conceal the RF sensor 232 within the housing 222 of the anti-theft tag 220. For example, when the second housing portion 230 is positioned in a closed position, the second housing portion 230 rotates relative to the first housing portion 228 about hinge member 236. A latch 240 of the second housing member 230 enters and interacts with a latch receptacle 242 of the first housing member 228 to secure the second housing portion 230 to the first housing portion 228. Such interaction maintains the RF sensor 232 within the housing 222 and limits the ability for a user to remove the RF sensor 132 from the anti-theft tag 220.

While various embodiments of the invention have been particularly shown and described, it will be understood by those skilled in the art that various changes in form and details may be made therein without departing from the spirit and scope of the invention as defined by the appended claims.

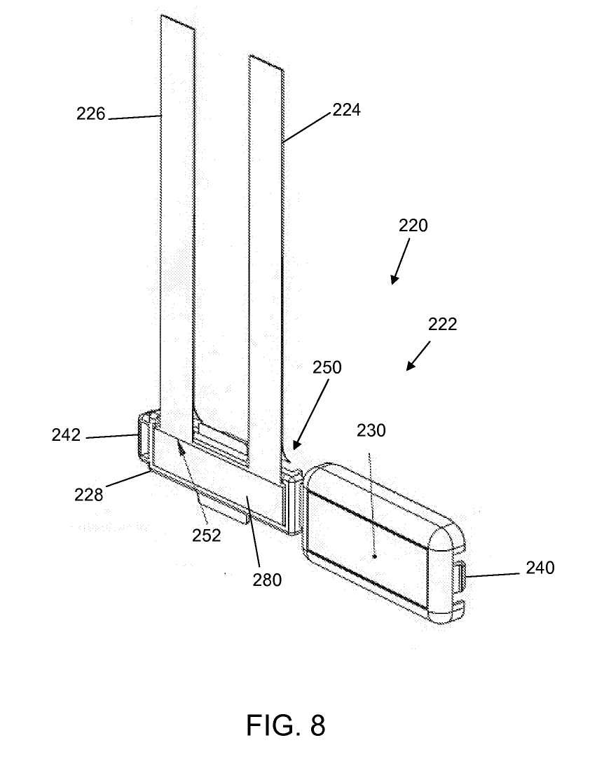

For example, FIG. 8 illustrates the ends 250, 252 of the respective first and second adhesive tape members 224, 226 are captured and secured between a contact pad 280 and the first housing portion 228. Such illustration is by way of example only. The ends 250, 252 of the respective first and second adhesive tape members 224, 226 can be secured to the first housing portion 228 in a variety of ways. For example, the ends 250, 252 of the respective first and second adhesive tape members 224, 226 are captured between an inner wall of the first housing portion 228 and a capturing element disposed within a cavity 281 defined by the first housing portion 228.

FIGS. 1-8 illustrate the anti-theft tag as having first and second adhesive tape members. Such illustration is by way of example only. The anti-theft tag can include any number of adhesive tape members. For example, the anti-theft tag can include a single adhesive tape member or three or more adhesive tape members to secure the housing to an elongate member.

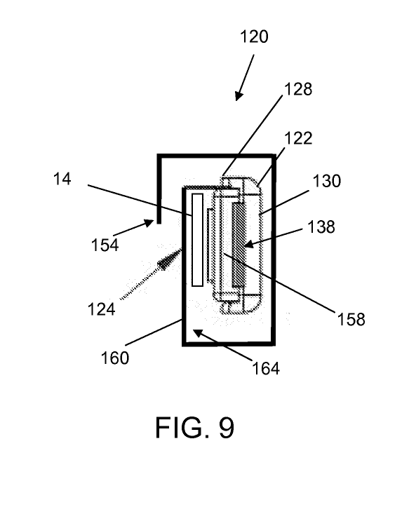

As described above, when an assembler applies an anti-theft tag to an elongate member, the assembler places the elongate member in proximity to the housing 122 of the anti-theft tag 102, the anti-theft tag 120 being disposed in its open position. The assembler then wraps the first and second adhesive tape members 124, 126 about the elongate member and the first housing portion 128 and secures the second housing portion 130 against the first housing portion 128. Such description is by way of example only. In one arrangement, as indicated in FIG. 9, the assembler places the elongate member in proximity to the housing 122 of the anti-theft tag 102, the anti-theft tag 120 being disposed in its closed position. After removing the adhesive tape member covering 168 from the first adhesive tape member 124, the assembler rotates the second end 154 of the first adhesive tape member 124 relative to the longitudinal axis 158 of the housing 122 such that the adhesive layer 164 of the first adhesive tape member 124 contacts the elongate member. The assembler then continues to rotate the first adhesive tape member 124 relative to the longitudinal axis 158 of the housing 122, thereby shortening an overall length of the of the first adhesive tape member 124 and causing the first adhesive tape member 124 to further secure the anti-theft tag 120 to the elongate member. For example, further rotation of the second end 154 of the first adhesive tape member 124 relative to the longitudinal axis 158 of the housing 122 causes the adhesive layer 164 of the first adhesive tape member 124 to contact the second housing portion 130 and to contact a non-adhesive bearing surface of the first adhesive tape member's carrier layer 160. Accordingly, the first adhesive tape member 124 is disposed about, or encircles, the elongate member and the housing 122 of the anti-theft tag 120 to secure the first end 151 of the housing 122 to the elongate member. The assembler then repeats the process with the second adhesive tape member 124 to secure the second end 153 of the housing 122 to the elongate member.

What is claimed is:

1. An anti-theft tag, comprising:
a housing constructed and arranged to support an electronic article surveillance (EAS) sensor; and
at least one adhesive tape member carried by and extending from the housing, the at least one adhesive tape member constructed and arranged to be positioned between a first state to allow positioning of at least a portion of an article in proximity to the housing and a second state wherein the at least one adhesive tape member is disposed about the housing and about the at least a portion of the article to secure the housing to the at least a portion of the article.

2. The anti-theft tag of claim 1, wherein the at least one adhesive tape member comprises a carrier layer having a first surface and a second surface, the second surface opposing the first surface, and an adhesive disposed on at least one of the first surface and the second surface of the carrier layer, the adhesive of the at least one adhesive tape member being configured to contact the at least a portion of the article and at least a portion of the housing when the at least one adhesive tape member is positioned in the second state.

3. The anti-theft tag of claim 2, wherein the at least one adhesive tape member comprises an adhesive tape member covering removably disposed on the at least one of the first surface and the second surface of the carrier layer having the adhesive.

4. The anti-theft tag of claim 2, wherein the at least one adhesive tape member defines a longitudinal axis, the at least one adhesive tape member extending from the housing such that the longitudinal axis of the at least one adhesive tape member is substantially perpendicular to a longitudinal axis of the housing.

5. The anti-theft tag of claim 1, wherein the at least one adhesive tape member comprises a first adhesive tape member carried by and extending from the housing and a second adhesive tape member carried by and extending from the housing.

6. The anti-theft tag of claim 5, wherein the first adhesive tape member is disposed at a first end of the housing and the second adhesive tape member is disposed at a second end of the housing, the first end of the housing opposing the second end of the housing.

7. The anti-theft tag of claim 1, wherein the housing comprises a first housing portion and a second housing portion, the first housing portion hingedly attached to the second housing portion, the second housing portion configured to be positioned between a first position and a second position relative to the first housing portion, the second housing portion configured to cover a cavity defined by the first housing portion when disposed in the second position.

8. The anti-theft tag of claim 7, wherein the EAS sensor is configured as an amplitude modulation (AM) sensor, the AM sensor disposed within the cavity defined by the first housing portion, at least a portion of the at least one adhesive tape member disposed within the cavity defined by the first housing portion and between the AM sensor and the first housing portion.

9. The anti-theft tag of claim 7, wherein the EAS sensor is configured as a radio frequency (RF) sensor, the RF sensor disposed within a cavity defined by the second housing portion.

10. The anti-theft tag of claim 1, comprising an elastomeric pad disposed on the housing, the elastomeric pad configured to minimize movement of the housing relative to the at least a portion of the article.

11. The anti-theft tag of claim 1, comprising an adhesive pad disposed on the housing, the adhesive material configured to secure the housing to at least a portion of the article.

12. An anti-theft tag, comprising:
a housing constructed and arranged to support an electronic article surveillance (EAS) sensor;
a first adhesive tape member carried by and extending from the housing, the first adhesive tape member defines a first member longitudinal axis, the first adhesive tape member extending from the housing such that the first member longitudinal axis of the first adhesive tape member is substantially perpendicular to a longitudinal axis of the housing, the first adhesive tape member constructed and arranged to be positioned between a first state to allow positioning of at least a portion of an article in proximity to the housing and a second state wherein the first adhesive tape member is disposed about at least a portion of the housing and about the at least a portion of the article to secure the housing to the at least a portion of the article; and
a second adhesive tape member carried by and extending from the housing, the second adhesive tape member defines a second member longitudinal axis, the second adhesive tape member extending from the housing such that the second member longitudinal axis of the second adhesive tape member is substantially perpendicular to the longitudinal axis of the housing, the second adhesive tape member constructed and arranged to be positioned between a first state to allow positioning of at least a portion of an article in proximity to the housing and a second state wherein the second adhesive tape member is disposed about at least a portion of the housing and about the at least a portion of the article to secure the housing to the at least a portion of the article.

13. The anti-theft tag of claim 12, wherein:
the first adhesive tape member comprises a carrier layer having a first surface and a second surface, the second surface opposing the first surface, and an adhesive disposed on at least one of the first surface and the second surface of the carrier layer, the adhesive of the first tape member being configured to contact the at least a portion of the article and at least a portion of the housing when the first adhesive tape member is positioned in the second state; and
the second adhesive tape member comprises a carrier layer having a first surface and a second surface, the second surface opposing the first surface, and an adhesive disposed on at least one of the first surface and the second surface of the carrier layer, the adhesive of the second adhesive tape member being configured to contact the at least a portion of the article and at least a portion of the housing when the second tape member is positioned in the second state

14. The anti-theft tag of claim 13, wherein:
the first adhesive tape member comprises an adhesive tape member covering removably disposed on the at least one of the first surface and the second surface of the carrier layer having the adhesive; and
the second adhesive tape member comprises an adhesive tape member covering removably disposed on the at least one of the first surface and the second surface of the carrier layer having the adhesive

15. The anti-theft tag of claim 12, wherein the first adhesive tape member is disposed at a first end of the housing and the second adhesive tape member is disposed at a second end of the housing, the first end of the housing opposing the second end of the housing.

16. The anti-theft tag of claim 12, wherein the housing comprises a first housing portion and a second housing portion, the first housing portion hingedly attached to the second housing portion, the second housing portion configured to be positioned between a first position and a second position relative to the first housing portion, the second housing portion configured to cover a cavity defined by the first housing portion when disposed in the second position.

17. The anti-theft tag of claim 16, wherein the EAS sensor is configured as an amplitude modulation (AM) sensor, the AM sensor disposed within the cavity defined by the first housing portion, at least a portion of the first adhesive tape member and the second adhesive tape member disposed within the cavity defined by the first housing portion and between the AM sensor and the first housing portion.

18. The anti-theft tag of claim 16, wherein the EAS sensor is configured as a radio frequency (RF) sensor, the RF sensor disposed within a cavity defined by the second housing portion.

19. The anti-theft tag of claim 12, comprising an elastomeric pad disposed on the housing, the elastomeric pad configured to minimize movement of the housing relative to the at least a portion of the article.

20. The anti-theft tag of claim 12, comprising an adhesive pad disposed on the housing, the adhesive material configured to secure the housing to at least a portion of the article.
